(19) United States
(12) Patent Application Publication
(10) Pub. No.: US 2020/0405093 A1
(43) Pub. Date: Dec. 31, 2020

(54) Apparatus Having Multi-Nozzles for Making Three-Dimensional Structure

(71) Applicant: Mandarin Robotics Inc., Dangjin-si (KR)

(72) Inventors: Keunho Rew, Dangjin-si (KR); Hui Gyu Park, Dangjin-si (KR)

(21) Appl. No.: 16/451,390

(22) Filed: Jun. 25, 2019

(51) Int. Cl. A47J 31/44; B33Y 30/00; B33Y 50/02; A23G 1/20

(52) U.S. Cl. CPC A47J 31/4496; B33Y 30/00; B33Y 70/00; A23G 1/202; B33Y 50/02

(57) ABSTRACT

The apparatus having multi-nozzles for making three-dimensional structure according to the present disclosure comprises a supply unit of raw material, the supply unit having a nozzle for supplying at least two raw materials; a seat unit provided under the supply unit, where a container receiving the raw material is seated; a driving unit for moving the supply unit and the seat unit in at least any one of X, Y, and Z directions; a control unit for controlling discharging amount and moving route of the driving unit, based on the desired shape of the structure to be made.

### TECHNICAL FIELD

The present disclosure relates to an apparatus having multi-nozzles for making three-dimensional structure, specifically to the apparatus which individually controls a plurality of dispensers containing materials of different properties to discharge the materials such that three-dimensional foam structure of various colors and shapes, for example three dimensional latte art on café latte is automatically made.

### BACKGROUND

According to the statistics, each Korean adult drank 512 cups of coffee in 2018 which amount to KRW 11.7 trillion. Coffee-related market has expanded by 200% for past ten years.

As the consumption of coffee soars, a variety of coffee shops and related products are on the market. Specialized coffee shops offer not only quality coffee but also a variety of additional services for differentiation from other shops.

For example, a two or three-dimensional latte art can improve aesthetics of coffee to attract the customer, thereby enhancing purchasing power.

However, a skillful barista of high salary is needed for latte art. Further, latte art needs a lot of practicing time.

Recently, developed is an apparatus which prints two-dimensional latte art on café latte by use of edible ink. However, the apparatus cannot make a three-dimensional latte art on the surface of the coffee.

### SUMMARY

The object of the present disclosure is to provide an apparatus having multi-nozzles which can make a variety of three-dimensional foam structures by use of 3D printing technologies.

The apparatus having multi-nozzles for making three-dimensional structure according to the present disclosure comprises a supply unit of raw material, which has a nozzle for supplying at least two raw materials; a seat unit provided under the supply unit, where a container receiving the raw material is seated; a driving unit for moving the supply unit and the seat unit in at least any one of X, Y, and Z directions; and a control unit for controlling discharging amount and moving route of the driving unit, based on the desired shape of the structure to be made.

The supply unit can comprise a dispenser having a containing tank for containing the raw material and a nozzle where the raw material is discharged; and a pneumatic device connected to the containing tank for supplying air pressure into the inside of the containing tank. The nozzle can be provided at the lower end of the containing tank.

At least two dispensers can be provided, and the pneumatic device includes single compressor for generating air pressure.

The apparatus can further comprise a solenoid valve provided on supply line for supplying air pressure to each dispenser. The control unit can individually control air pressure supplied to each dispenser.

The driving unit can comprise a first driving portion for moving the dispenser in XY directions and a second driving portion for moving the seat unit in Z direction.

The first driving portion can comprise a Y-direction moving body which moves in Y-direction; a guide rail provided along the Y-direction moving body; and a X-direction moving body provided in the guide rail, which moves along the guide rail in X-direction.

The X-direction moving body can have a bracket connected to the one side thereof.

The bracket can be a ring shape having a portion removed. The dispenser can have a step in its lower end, which can be seated on upper surface of the bracket.

The apparatus of the present disclosure can further comprise a holder for supporting the container. The holder can be provided on the upper surface of the seat unit.

The control unit can control the pressure of the compressor by PWM, and duty parameters can be adjusted based on the properties of each raw material, thereby controlling discharging amount of raw material.

The control unit controls the driving unit based on the output type predetermined based on the properties of the raw material. The output type can be predetermined as one of multi-layered output type and single-layered output type.

The apparatus of the present disclosure can further comprise a barrier which has a plurality of elastic pieces which are opened when the raw material is discharged by the air pressure applied to the inside of the containing tank. The elastic pieces are closed when the air pressure decreases, thereby preventing the raw material from being discharged.

The center of the barrier can be cut into a cross shape to form four elastic pieces.

Raw material having a viscosity higher than a predetermined value can be contained in the dispenser having the barrier. The raw material can be melted chocolate.

### BRIEF DESCRIPTION OF DRAWINGS

FIG. 1 is a perspective view of the apparatus according to the present disclosure.

FIG. 2 is a partial view of the apparatus of FIG. 1 where dispensers are separated from bracket.

FIGS. 3 to 6 are perspective views of the apparatus of FIG. 1 when it operates.

FIG. 7 is an example of output control instructions of control unit of the apparatus according to the present disclosure.

FIG. 8 is a connecting portion of discharging nozzle of the present disclosure.

FIG. 9 is an example of three-dimensional structure which is made by the apparatus of the present disclosure.

FIG. 10 is a block diagram for showing the process of making three-dimensional structure by the apparatus of the present disclosure.

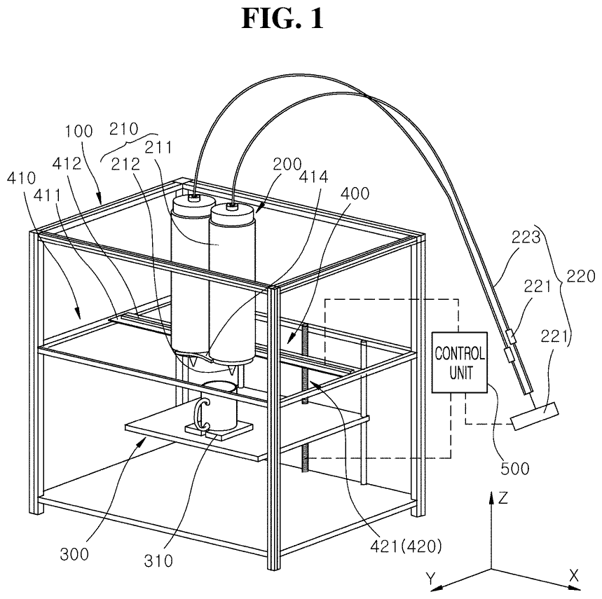

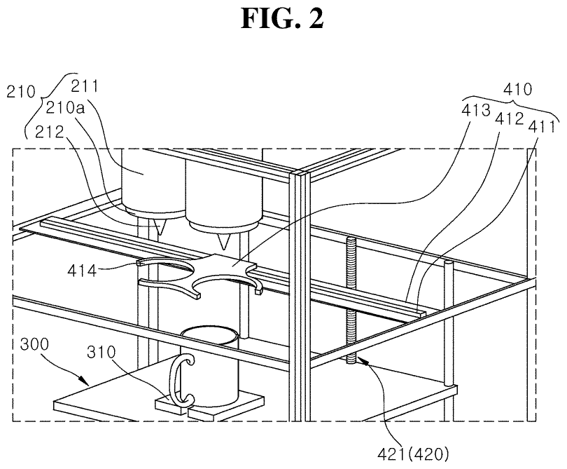

### DETAILED DESCRIPTION

Hereinafter, the present disclosure will be described in detail with reference to the accompanying drawings.

As those skilled in the art would realize, the described embodiments may be modified in various different ways, all without departing from the spirit or scope of the present disclosure.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure

The apparatus of the present disclosure comprises a casing (100), a supply unit of raw material (200), a seat unit (300), a driving unit (400) and a control unit (500).

The casing (100) can be a shape of hexahedron. The supply unit (200) of raw material, the seat unit (300) and the driving unit (400) can be provided within the casing (100).

The supply unit (200) comprises nozzles (212) through which at least two raw materials are discharged to a container on the seat unit (300). The container can be provided under the nozzle.

The supply unit (200) can comprise a dispenser (210) and a pneumatic device (220) for supplying air pressure to the dispenser to discharge raw material.

The dispenser (210) can comprise a containing tank (211) and a nozzle (212), through which the raw material contained in the containing tank (211) is discharged. The nozzle (212) can be provided at the lower end of the containing tank (211).

In this specification, the apparatus having two dispensers (210) is exemplarily described. However, it should be understood that the apparatus having more than two dispensers can be conceived without departing from the scope and the spirit of the present disclosure.

The pneumatic device (220) can be connected to the upper end of the containing tank (211) so as to supply air pressure to the inside of the containing tank (211), thereby discharging the raw material in the containing tank through the nozzle.

A supply line (223) can be connected between the pneumatic device (220) and the dispenser (210) to supply air pressure to the dispenser (210). Air pressure can be supplied through the supply line by a small compressor (221) of diaphragm type. Although it is illustrated that the pneumatic device of the present disclosure generates air pressure by a single compressor (221), air pressure can be generated by two or more compressors.

A solenoid valve (222) can be provided in the supply line (223) to individually control the air pressure supplied to each dispenser (210).

The seat unit (300) can be provided under the supply unit (200). A container for receiving the raw material from the nozzle is seated on the upper surface of the seat unit (300). A holder (310) for holding the container can be provided on the upper surface of the seat unit (300). The holder (310) can support the outer portion of the container such that the container does not fall by an external impact while the three-dimensional structure is made.

The driving unit (400) moves the supply unit (200) and the seat unit (300) in at least any one of X, Y, and Z directions. The driving unit (400) can comprise a first driving portion (410) for moving the dispenser (210) in XY directions and a second driving portion (420) for moving the seat unit (300) in Z direction.

The first driving portion (410) comprises a Y-direction moving body (411) which forwardly and backwardly moves in the casing (100), a guide rail (412) which is provided on the Y-direction moving body along the longitudinal direction of the moving body (411), and a X-direction moving body (413) which is mounted on the guide rail (412) and has a bracket (414) supporting the dispenser (210). The X-direction moving body (413) moves on the guide rail (412).

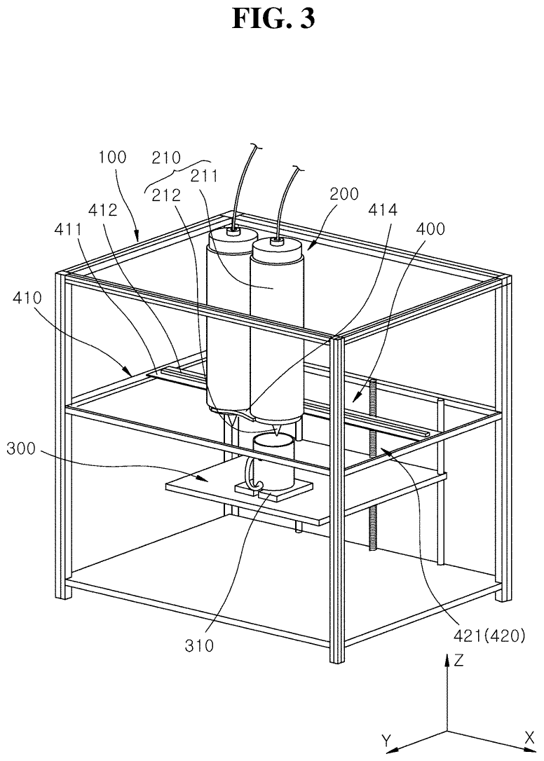

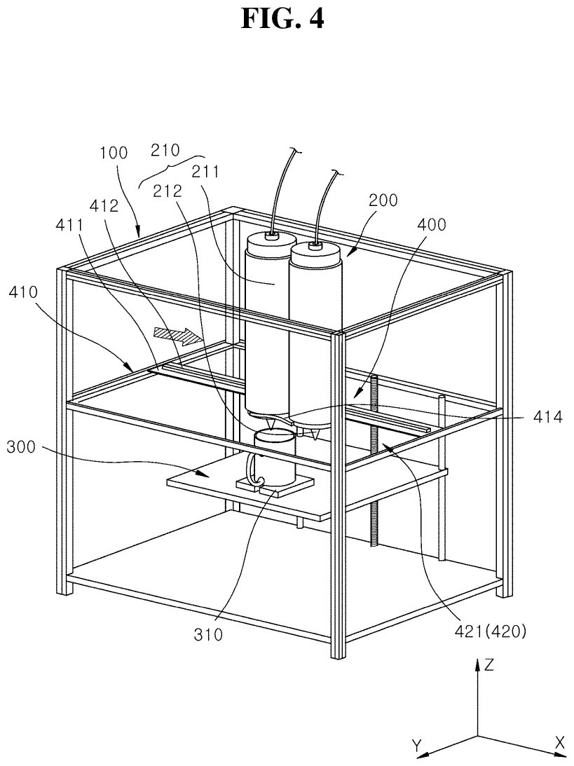

The first driving portion (410) moves in XY directions according to control instructions of the control unit (500) such that the nozzle (212) of the dispenser (210) moves to a desired position as shown in FIGS. 3 and 4.

The bracket (414) can be a shape of ring having a portion removed. The containing tank (211) can have a step formed in its lower end, which is seated on the upper surface of the bracket (414).

The inner diameter of the bracket (414) can be smaller than the outer diameter of the containing tank (211), thereby increasing the fixing force between the bracket and the tank.

According to the present disclosure, the dispenser (210) can be easily supported or removed from the bracket (414).

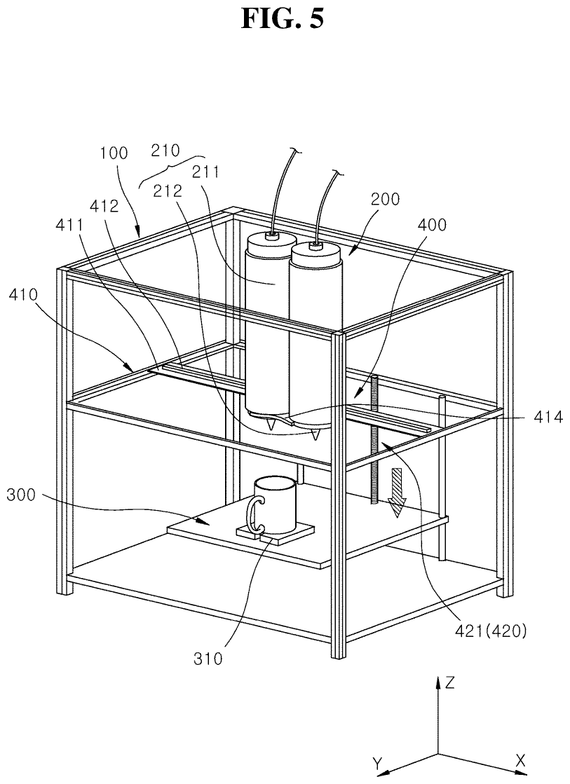

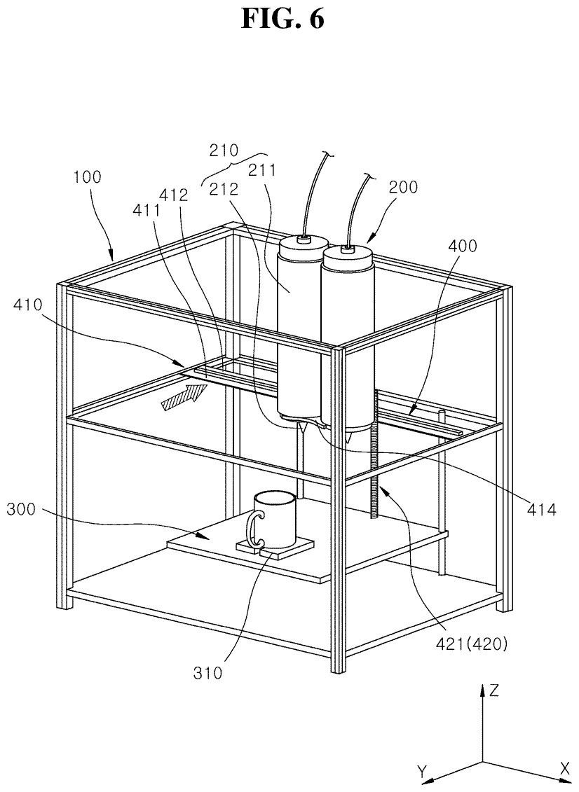

The second driving portion (420) comprises an elevating bolt (421) which extends along the height direction of the casing (100), and a supporting plate (300) which is connected to the elevating bolt (421). The supporting plate (300) can move up and down in accordance with the rotation of the elevating bolt (421) as shown in FIG. 5.

The control unit (500) controls the discharging amount of the raw material and the moving route of the driving unit (400) such that a desired structure can be made.

The control unit (500) can be operated by a technique which is similar to FDM (Fused Deposition Modeling).

According to the conventional FDM, 3D model to be made is transformed to STL file. The cross-sectional layers are generated by a slicing program (eg. Ultimaker CURA) and then, the instructions for 3D movement and nozzle control are generated.

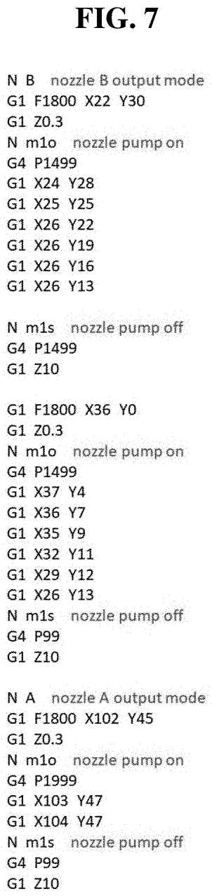

The conventional instructions for 3D movement is generated as Gcode which consists of character strings. The Gcode includes instruction codes for motor displacement, heater temperature, on/off of an apparatus and the like. The specific codes following the instruction codes includes character strings for output speed, moving position, supply amount of filament and the like. Gcode for the present disclosure further generates a special code which starts with “N” in order to control multi-nozzles. FIG. 7 shows an example of Gcode according to the present disclosure.

At least one dispenser (210) can contain a raw material of foam. The discharging amount of foam can be controlled by the control unit (500). The control unit (500) can control the amount by PWM (Pulse Width Modulation). Duty parameters are adjusted according to the properties of each raw material such that discharging instructions which is optimal to each material are generated.

The compressor (221) periodically applies pressure at a time when the inner pressure of the containing tank (211) decreases due to discharging of raw material.

The control unit (500) also generates instructions for moving the driving unit (400) based on the output type which is predetermined according to the properties of the raw material. The output type can be determined as one of multi-layered output type and single-layered output type.

If foam is discharged according to the multi-layered output type, the border lines between layers are clearly shown such that the appearance of the structure is not so good. Thus, it is preferred that foam is discharged according to the single-layered output type.

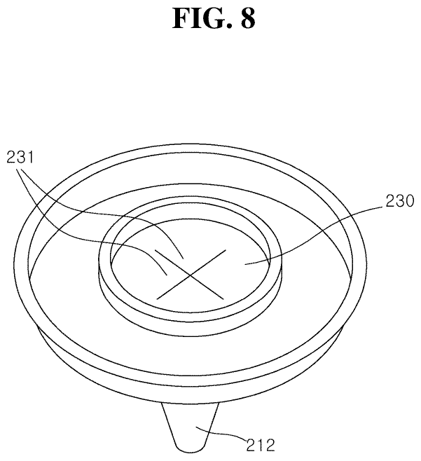

FIG. 8 shows the connecting portion of the nozzle. As illustrated in FIG. 8, a barrier (230) can be further provided in the inside of the nozzle (212). The barrier (230) helps discharge raw material above a certain pressure and prevent raw material from being discharged when pressure is lowered.

The center of the barrier (230) can be cut to provide a plurality of elastic pieces which can be opened above a certain pressure. The center of the barrier (230) can be cut into a cross shape to provide four elastic pieces.

When air pressure is applied to the containing tank (211), the elastic pieces (231) are opened and then the raw material is discharged through the nozzle (212). When the air pressure in the containing tank (211) decreases, the elastic pieces (231) close the barrier to prevent the raw material from being discharged.

The raw material having a high viscosity are pulled long without being broken due to high viscosity even if air pressure is removed. The barrier (230) can promote discharge interruption. This is very useful when melted chocolate of high viscosity is used as raw material.

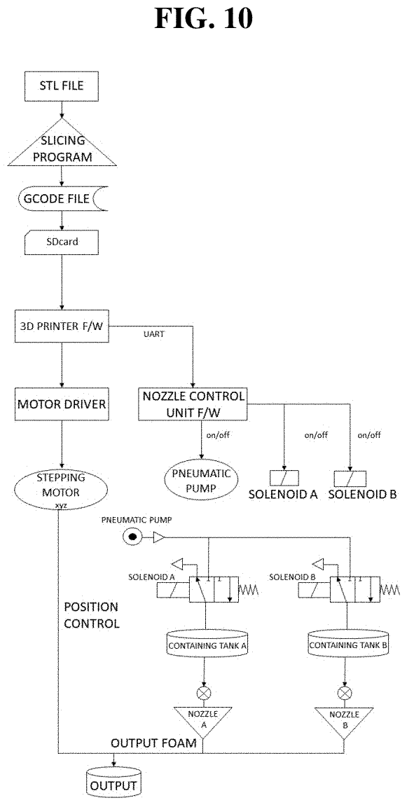

Block diagram illustrating the process of making three-dimensional foam structure on café latte is shown in FIG. 10.

A dispenser (210) containing milk foam and a dispenser (210) containing melted chocolate are supported at the bracket (414). The barrier (230) is provided at the nozzle (212) of the dispenser (210) containing the melted chocolate.

A container where café latte is contained is supported by the holder (310) of the seat unit (300).

The control unit (500) generates Gcode for 3D movement as described in the above. Gcode can include instruction codes for individually controlling the multi-nozzles. The Gcode can also include the information of output type and the discharging pressure which is predetermined according to the structure to be made.

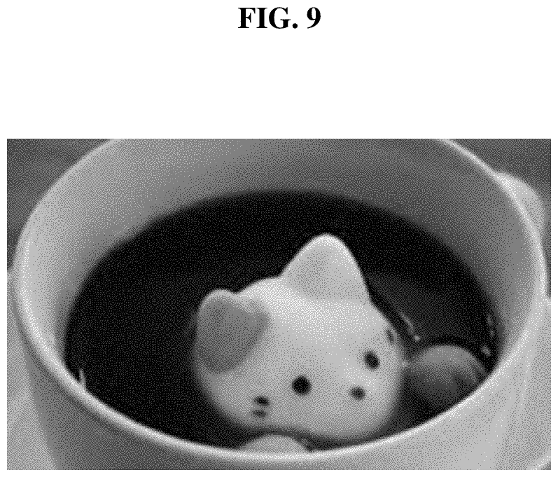

FIG. 9 shows a three-dimensional structure on the café latte which is made according to the present disclosure.

While the present disclosure has been described with reference to the accompanying drawings, it should be appreciated that the scope of the present disclosure is determined by the appended claims and that the scope is not limited to the embodiments and/or the drawings. It is to be appreciated that a person skilled in the art can change or modify the embodiments without departing from the scope and spirit of the present disclosure.

1. An apparatus having multi-nozzles for making three-dimensional structure comprising:
a supply unit of raw material, the supply unit having a nozzle for supplying at least two raw materials;
a seat unit provided under the supply unit, where a container receiving the raw material is seated;
a driving unit for moving the supply unit and the seat unit in at least any one of X, Y, and Z directions;
a control unit for controlling discharging amount and moving route of the driving unit, based on the desired shape of the structure to be made.

2. The apparatus according to claim 1, wherein the supply unit comprises a dispenser having a containing tank for containing the raw material, and a nozzle where the raw material is discharged, the nozzle being provided at the lower end of the containing tank; and a pneumatic device connected to the containing tank for supplying air pressure into the inside of the containing tank.

3. The apparatus according to claim 2, wherein at least two dispensers are provided, and the pneumatic device includes single compressor for generating air pressure.

4. The apparatus according to claim 3, further comprising a solenoid valve provided in supply line for supplying air pressure to each dispenser, wherein the control unit individually controls air pressure supplied to each dispenser.

5. The apparatus according to claim 3, wherein the driving unit comprises a first driving portion for moving dispenser in XY directions and a second driving portion for moving the seat unit in Z-direction.

6. The apparatus according to claim 5, wherein the first driving portion comprises a Y-direction moving body which moves in Y-direction; a guide rail provided along the Y-direction moving body; and a X-direction moving body provided in the guide rail and having a bracket connected to the one side thereof, which moves along the guide rail in X direction.

7. The apparatus according to claim 6, wherein the bracket is a ring shape having a portion removed; the dispenser having a step in its lower end; and the step is seated on upper surface of the bracket.

8. The apparatus according to claim 1, further comprising a holder for supporting the container, the holder being provided on the upper surface of the seat unit.

9. The apparatus according to claim 3, wherein at least one dispenser contains raw material of foam.

10. The apparatus according to claim 9, wherein the control unit controls the pressure of the compressor by PWM, and duty parameters are adjusted based on the properties of each raw material, thereby controlling discharging amount of raw material.

11. The apparatus according to claim 10, wherein the control unit controls the driving unit based on the output type predetermined based on the properties of the raw material, the output type being predetermined as one of multi-layered output type and single-layered output type.

12. The apparatus according to claim 2, further comprising a barrier having a plurality of elastic pieces which are opened when the raw material is discharged by the air pressure applied to the inside of the containing tank, and which are closed when the air pressure decreases, thereby preventing the raw material from being discharged.

13. The apparatus according to claim 12, wherein the center of the barrier is cut into a cross shape, thereby forming four elastic pieces.

14. The apparatus according to claim 13, wherein raw material having a viscosity higher than a predetermined value is contained in the dispenser having the barrier.

15. The apparatus according to claim 14, wherein the raw material having a viscosity higher than a predetermined value is melted chocolate.
